(19) United States
(12) Patent Application Publication
(10) Pub. No.: US 2009/0080197 A1
(43) Pub. Date: Mar. 26, 2009

(54) LIGHT EMITTING DIODE MODULE AND METHOD FOR THE MANUFACTURING OF SUCH AN LED MODULE

(75) Inventors: Klemens Brunner, Eindhoven (NL); Aldegonda Lucia Weijers, Eindhoven (NL); Norbertus Antonius Maria Sweegers, Eindhoven (NL); Cornelis Gerardus Visser, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/293,092

(22) PCT Filed: Mar. 14, 2007
(86) PCT No.: PCT/IB2007/050863

§ 371 Date: Sep. 16, 2008

(30) Foreign Application Priority Data
Mar. 21, 2006 (EP) 06111432.8

(51) Int. Cl. F21V 7/00; F21K 7/00

(52) U.S. Cl. 362/296.01; 362/257

(57) ABSTRACT

The present invention relates to a light emitting diode (LED) module (10) comprising an LED (14) chip for emitting light, which LED chip is mounted on a substrate (12), and an optical element (16) positioned on top of the LED chip for converting the wavelength of at least part of the light emitted from the LED chip. The LED module is characterized by means (18, 20, 22, 24, 26, 28, 32, 34) for laterally and angularly aligning the optical element with the LED chip. The alignment means ensure that the optical element automatically aligns itself to the LED chip when it is placed on the chip, and that the correct position and orientation of the optical element is maintained during subsequent manufacturing and operation of the LED module. The present invention also relates to a method for the manufacturing of such an LED module.

The present invention relates to a light emitting diode (LED) module comprising an LED chip for emitting light, which LED chip is mounted on a substrate, and an optical element positioned on top of the LED chip for receiving light emitted from the LED chip. The present invention also relates to a method for the manufacturing of such an LED module.

An example of a light-emitting device of the type described above is disclosed in for example the document US20050110034. In US20050110034, an LED chip is mounted in a flip-chip manner on leads with its electrodes or contacts facing the leads. The light emitting device further comprises an optical element, namely a fluorescent plate, glued on top of the LED chip, that is on the opposite side of the LED chip with respect to the contacts. The function of the plate is to convert some of the light emitted from the LED chip into light of a different wavelength in order to produce for example white light. The light is out-coupled on the topside of the conversion plate, that is on the side of the plate opposite where the LED chip is connected to the converter plate.

Such conversion plates, as well as other optical elements such as a lens or a filter, have to be positioned very exact on top of the LED chip. Wrong positioning can affect both inter device consistency and intra device consistency. As for the former, if a conversion plate is not positioned correctly with respect to the LED chip, the result will be variations in color point and efficiency between several devices where the plates are mounted in different ways. As for the latter, the color point for a single LED module as function of the emission angle depends largely on the correct positioning of the conversion plate with respect to the LED chip, whereby the color point changes as function of emission angle if the plate is displaced, tilted, or wrongly mounted otherwise. That is, the color of the LED will change depending on the viewing angle.

This exact positioning can be a serious issue in high speed pick and place production facilities for two reasons: 1) the production machine does not place the optical element correctly, in the first place, and 2) the optical element is placed correctly but moves from its position during further processing.

It is an object of the present invention to overcome this problem, and to provide an improved LED module which facilitates exact positioning of the optical element with respect to the LED chip. Another object is to provide an LED module where the optical element is kept in place with respect to the LED chip during further processing and operation.

These and other objects that will be evident from the following description are achieved by means of an LED module, and a method for the manufacturing of such an LED module, according to the appended claims.

According to one aspect of the invention, there is provided an LED module, comprising an LED chip for emitting light, which LED chip is mounted on a substrate, and an optical element positioned on top of the LED chip for receiving light emitted from the LED chip, which LED module is characterized by means for laterally and angularly aligning the optical element with the LED chip.

The alignment means can advantageously ensure that 1) the optical element automatically aligns itself to the LED chip when it is placed on the chip, and that 2) the correct position and orientation of the optical element is maintained during subsequent manufacturing and operation of the LED module. Thus, such an LED module is suitable for manufacturing using a high speed pick and place process.

The alignment means can be provided on at least one of the optical element and the substrate. In one embodiment, the alignment means comprise at least one element extending downwards from the optical element for engaging the LED chip That is, the alignment means are here provided on the optical element. The at least one element can for example be pillars on at least two sides of the optical element (such as one pillar on each of two neighboring sides of an optical element with essentially square base), or angle bars on at least two corners of the optical element (i.e. “extended corners”).

Alternatively, the at least one downwardly extending element can be one or more rims provided along a substantial part of the circumference of the optical element. The rim(s) can be made of the same or a similar material as the optical element. This is especially advantageous if the optical element is a color conversion plate, in which case any light emitted on the side of the LED chip can be converted. This ensures a smaller angular distribution of the color temperature, compared to a case where unconverted light “escapes” from the side of the LED chip. Thus, not only does such alignment means ensure correct and easy alignment of the conversion plate to the LED chip, but they also cause the dependency between color temperature and viewing angle to be alleviated. Alternatively, the rim(s) can have a specular or diffuse reflective inner our outer surface, in order to reflect light emitted on the side of the LED chip back into the LED chip and/or the optical element, to increases the brightness and/or efficiency of the LED module.

In another embodiment, the alignment means comprise at least one element extending upwards from the substrate for engaging the optical element. That is, the alignment means are here provided on the substrate. An advantage with this embodiment is that the optical element not necessarily has to have a larger area than the LED chip. The at least one element can for example be pillars adapted to engage at least two sides of the optical element, or angle bars adapted to engage at least two corners of the optical element.

Alternatively, the at least one upwardly extending element can be one or more rims adapted to engage a substantial part of the circumference of the optical element. As above, the rim(s) can be made of the same or a similar material as the optical element, or have a specular or diffuse reflective inner or outer surface.

It should be noted that the alignment means can be provided on both the optical element and the substrate. For example, the optical element can be provided with downwardly extending pillars on opposite sides of the optical element, while the substrate is provided with upwardly extending pillars adapted to engage the optical element on the remaining sides of the optical element.

The above LED chip can for example be mounted to the substrate in flip-chip mode, i.e. the chip is mounted upside down. However, in another embodiment, the LED chip can be electrically connected by means of bonding wires, either directly or via the substrate. Here, the bonding wires can function as the alignment means. Alternatively, pads connecting the bonding wires with the LED chip or the substrate can be the alignment means. One bonding wire and/or pad can be for example positioned on each side of the LED chip and optical element, for secure alignment.

The above optical element can for example be a conversion plate for converting the wavelength of at least part of there light emitted from the LED chip. Preferably, the conversion plate is a solid-state conversion plate. Alternatively, the optical element can example be a lens or a filter. The above alignment means are particularly suitable for an optical element having a substantially square base.

According to another aspect of the invention, there is provided a method for the manufacturing of a light emitting diode (LED) module comprising mounting an LED chip on a substrate, the LED chip being adapted to emit light, and preparing an optical element adapted to be positioned on top of the LED chip for receiving light emitted from the LED chip, which method is characterized in that at least one of the substrate and the optical element is provided with means for laterally and angularly aligning the optical element with the LED chip, and in that the method further comprises positioning the optical element on top of the LED chip, whereby the alignment means align the optical element with the LED chip. The optical element can for example be a color conversion plate. This aspect of the invention exhibits similar advantages as the previously discussed aspect of the invention.

These and other aspects of the present invention will now be described in more detail, with reference to the appended drawings showing currently preferred embodiments of the invention.

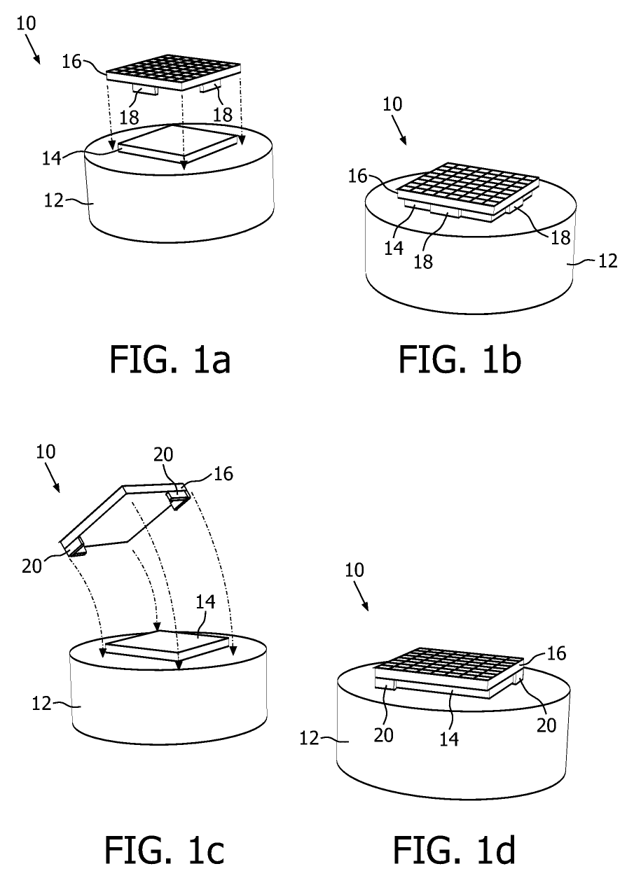

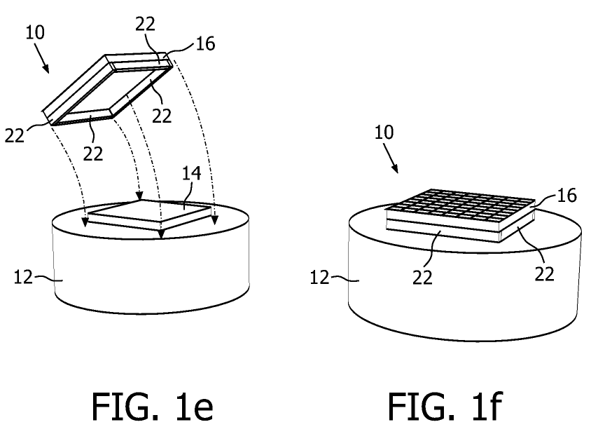

FIGS. 1a-1f show different variants of an LED module according to an embodiment of the present invention,

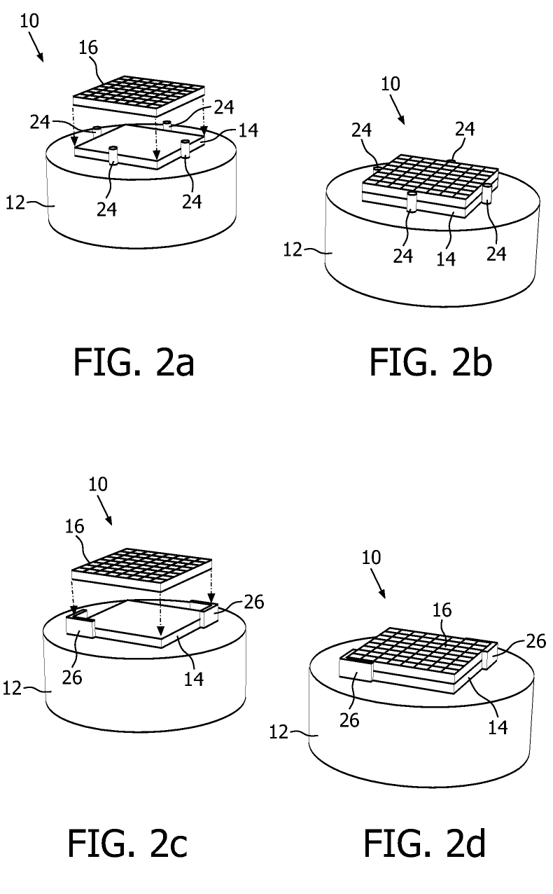

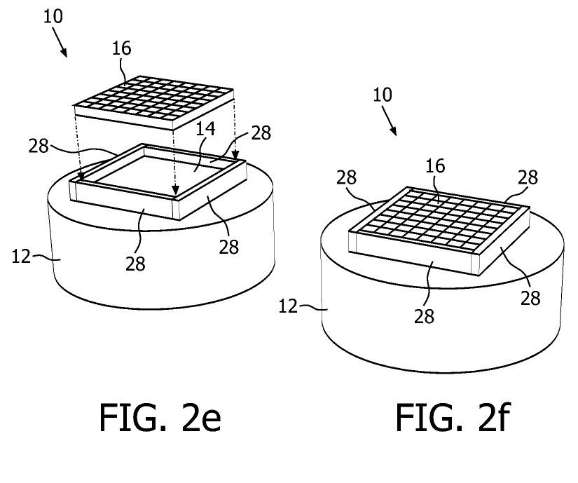

FIGS. 2a-2f show different variants of an LED module according to another embodiment of the present invention,

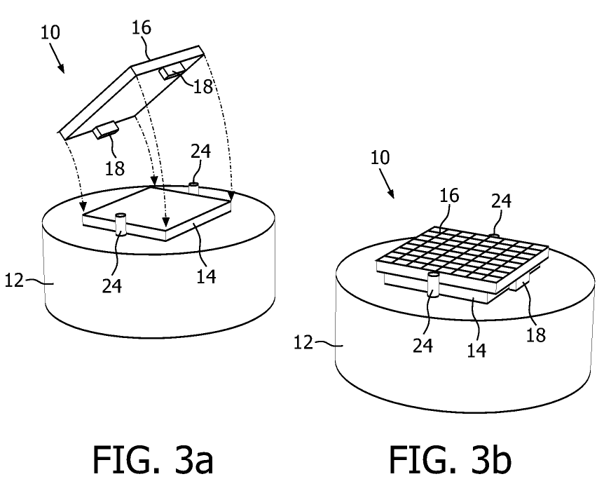

FIGS. 3a-3b show an LED module according to yet another embodiment of the present invention, and

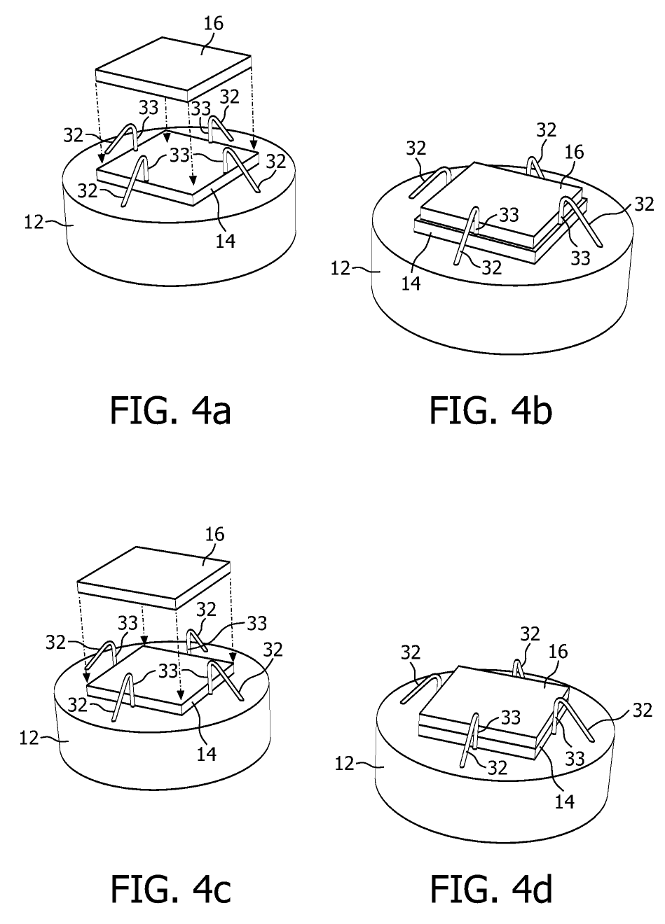

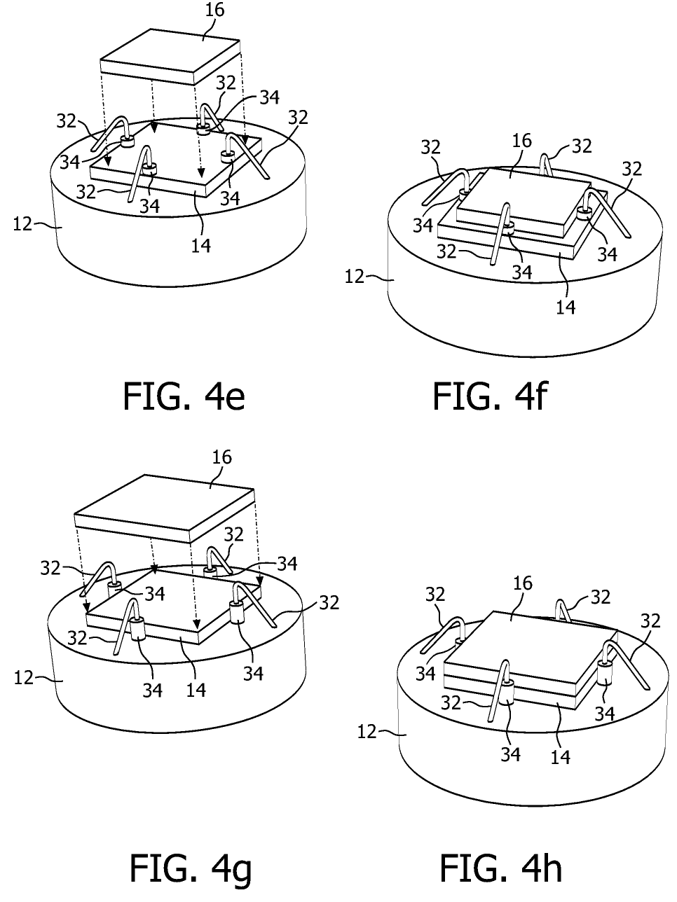

FIGS. 4a-4h show different variants of an LED module according to still another embodiment of the present invention.

FIGS. 1a-1f are perspective views showing different variants of an LED module 10 according to an embodiment of the present invention. The LED module 10 comprises a substrate 12 onto which an LED chip 14 adapted to emit light is mounted. The LED chip 14 in FIGS. 1a-1f is a flip chip having contacts (not shown) on its underside towards the substrate 12 for electrical connection to a current source (not shown). The LED module 10 further comprises an optical element, namely a conversion plate 16, to be mounted on top of the LED chip 14.

The conversion plate 16 is adapted to convert the wavelength of at least part of the light emitted from the LED chip 14. The LED chip 14 can for example emit blue light, a part of which is converted to yellow/orange light by means of the conversion plate 16, whereby the combined emission of the non-converted blue LED emission and the yellow/orange converted light gives a white impression. Alternatively, an LED emitting UV radiation can be used, which UV radiation for example can be converted into blue/red/green light. As another alternative, the conversion plate can be used to essentially fully convert blue light from a blue LED chip into red or green light using red or green phosphor, whereby light from an unconverted blue LED, light from a blue LED chip with a conversion plate for conversion into red light, and light from a blue LED chip with a conversion plate for conversion into green light can be mixed to white light. The conversion plate is preferably a solid-state ceramic conversion plate. A suitable conversion plate is disclosed in for example the document US2005/0569582.

According to an embodiment of the invention, the conversion plate 16 comprises at least one element extending downwards from the conversion plate 16 for engaging the LED chip 14, in order to laterally and angularly aligning the conversion plate 16 with the LED chip 14.

In FIGS. 1a-1b, the at least one element is constituted by two pillars 18. One pillar 18 is arranged on one side of the conversion plate 16, while the other pillar 18 is arranged on an adjacent side of the conversion plate 16. FIG. 1a shows the conversion plate 16 before it is placed on the LED chip 14, while FIG. 1b show the conversion plate in position on the LED chip 14. When the conversion plate 16 is positioned on the LED chip 14, the pillars 18 engages the sides of the LED chip 14, and prevents the conversion plate 16 from being laterally and/or angularly displaced (i.e. being displaced sideways and/or rotated). Also, the pillars 18 facilitate the initial placing of the conversion plate 16 on the LED chip 14.

In FIGS. 1c-1d, instead of pillars, the conversion plate 16 is provided with two angle bars 20, each being provided on an opposite corner of the conversion plate 16. The angle bars 20 function as “extended corners” of the conversion plate 16. The angle bars 20 engages the corners of the LED chip 14 when the conversion plate 16 is positioned on the LED chip 14, and prevents the conversion plate 16 from being laterally and/or angularly displaced. Also, they facilitate the initial placing of the conversion plate 16 on the LED chip 14.

In FIGS. 1e-1f, the at least one element for laterally and angularly aligning the conversion plate 16 with the LED chip 14 is constituted by rims 22 provided along a substantial part of the circumference of the conversion plate 16. Alternatively, a single circumferential rim extending along essentially the entire circumference of the conversion plate 16 can be used. The rim(s) 22 can be made of the same or a similar material as the conversion plate 16, such as YAG:Ce, whereby any light emitted on the side of the LED chip 14 also can be converted. Alternatively, the rim(s) 22 can have a specular or diffuse reflective inner our outer surface, in order to reflect light emitted on the side of the LED chip 14 back into the LED chip 14 and/or the conversion plate 16, to increases the brightness and/or efficiency of the LED module 10. The reflective surface can for example be realized by evaporating Ag onto the rim(s) 22 (which nevertheless can be made of the same or a similar material as the conversion plate 16, for simple manufacturing), or by using rims (22) made of a reflective material.

According to another embodiment of the invention, the substrate 12 comprises at least one element extending upwards from the substrate 12 for engaging the conversion plate 16, in order to laterally and angularly align the conversion plate 16 with the LED chip 14. Different variants of this embodiment are shown in FIGS. 2a-2f.

The at least one element on the substrate 12 can comprise four pillars 24 (FIGS. 2a-2b) adapted to engage the four sides of the conversion plate, or it can comprise two angle bars 26 (FIGS. 2c-2d), each being adapted to engage an opposite corner of the conversion plate 16. Alternatively, it can be comprise one or more rims 28 (FIGS. 2e-2f) adapted to engage a substantial part of the circumference of the conversion plate 16. As described in relation to FIGS. 1e-1f, the rim(s) 28 can be made of the same or a similar material as the conversion plate 16, or have a specular or diffuse reflective inner or outer surface.

When the conversion plate 16 is positioned on the LED chip 14, the pillars 24, angular bars 26, or rims 28 engage the conversion plate 16, and prevents it from being laterally and/or angularly displaced. Also, the pillars 24/angular bars 26/rims 28 facilitate the initial placing of the conversion plate 16 on the LED chip 14. An advantage with this embodiment compared to the embodiment discussed in relation to FIGS. 1a-1f above is that the conversion plate 16 not necessarily has to be larger than the LED chip 14.

In yet another embodiment of the present invention, both the substrate 12 and the conversion plate 16 can be provided with alignment means (i.e. a combination of the first two embodiments). For example, the conversion plate 16 can be provided with downwardly extending pillars 18 on opposite sides of the conversion plate 16, while the substrate 12 is provided with upwardly extending pillars 24 adapted to engage the conversion plate 16 on the remaining sides of the conversion plate 16, as illustrated in FIGS. 3a-3b.

FIGS. 4a-4h show different variants of an LED module 10 according to still another embodiment of the present invention. In this embodiment, the LED chip 14 is electrically connected to a current source (not shown) by means of bonding wires 32. One bonding wire 32 is arranged at each side of the square LED chip 14 and conversion plate 16 (only two out of four bonding wires 32 are shown in FIGS. 4a-4h). The bonding wires 32 are designed to engage the conversion plate 16 in order to laterally and angularly align the conversion plate 16 with the LED chip 14. The bonding wires 32 can be connected either directly to the LED chip (FIGS. 4a-4b) or via the substrate 12 (FIGS. 4c-4d), wherein an essentially vertical portion 33 of each bonding wire 32 engages the conversion plate 16 and prevents it from being moved sideways or rotated. Also, pads 34 connecting the bonding wires 32 with the LED chip 14 (FIGS. 4e-4f) or the substrate 12 (FIGS. 4g-4h) can have the same aligning function as the mentioned bonding wires.

The person skilled in the art realizes that the present invention by no means is limited to the preferred embodiments described above. On the contrary, many modifications and variations are possible within the scope of the appended claims. For example, even though the above examples relate to a color conversion plate, the alignment means according to the invention can advantageously be used to align other optical elements, such as a lens or a filter.

Further, in relation to FIGS. 1a-1b, pillars can be provided at more that two sides of the conversion plate, for example one pillar on each side of the square conversion plate. Also, in relation to FIGS. 1a-1b and 2a-2b, more than one pillar can be provided at each side of the conversion plate. Further, in relation to FIGS. 1c-1d and 2c-2d, angular bars can be provided at more than two corners of the conversion plate. Further, in relation to FIGS. 1e-1f and 2e-2f, the rims can be provided at two or three sides only, wherein the rims can be seen as “elongated pillars”.

Further, in the combined embodiment, an example of which is disclosed in FIGS. 3a-3b, other combinations are possible, for example angular bars can extend from the substrate to engage two opposite corners of the conversion plate, while pillars are provided at two opposite sides of the conversion plate to engage the corresponding sides of the LED chip.

Also, the directional features in the appended claims are intended to indicate relative intra-device directions, regardless of the overall device's direction.

1. A light emitting diode (LED) module (10), comprising:
an LED chip (14) for emitting light, which LED chip is mounted on a substrate (12), and
an optical element (16) positioned on top of the LED chip for receiving light emitted from the LED chip,
characterized by
means (18, 20, 22, 24, 26, 28, 32, 34) for laterally and angularly aligning the optical element with the LED chip.

2. An LED module according to claim 1, wherein the alignment means are provided on at least one of the optical element and the substrate.

3. An LED module according to claim 2, wherein the alignment means comprise at least one element extending downwards from the optical element for engaging the LED chip.

4. An LED module according to claim 3, wherein said at least one element is pillars (18) on at least two sides of the optical element.

5. An LED module according to claim 3, wherein said at least one element is angle bars (20) on at least two corners of the optical element.

6. An LED module according to claim 3, wherein said at least one element is one or more rims (22) provided along a substantial part of the circumference of the optical element.

7. An LED module according to claim 2, wherein the alignment means comprise at least one element extending upwards from the substrate for engaging the optical element.

8. An LED module according to claim 7, wherein said at least one element is pillars (24) adapted to engage at least two sides of the optical element.

9. An LED module according to claim 7, wherein said at least one element is angle bars (26) adapted to engage at least two corners of the optical element.

10. An LED module according to claim 7, wherein said at least one element is one or more rims (28) adapted to engage a substantial part of the circumference of the optical element.

11. An LED module according to claim 6, wherein the rims are made of the same or a similar material as the optical element.

12. An LED module according to claim 6, wherein the rims have a reflective inner or outer surface.

13. An LED module according to claim 1, wherein the LED chip is a flip-chip.

14. An LED module according to claim 1, wherein the LED chip is electrically connected by means of bonding wires (32).

15. An LED module according to claim 14, wherein the bonding wires are the alignment means.

16. An LED module according to claim 14, further comprising pads (34) connecting the bonding wires with the LED chip or the substrate, and wherein the pads are the alignment means.

17. An LED module according to claim 1, wherein the optical element is a conversion plate (16) for converting the wavelength of at least part of the light emitted from the LED chip.

18. An LED module according to claim 17, wherein the conversion plate is a solid-state conversion plate.

19. A method for the manufacturing of a light emitting diode (LED) module, comprising:
mounting an LED chip on a substrate, the LED chip being adapted to emit light, and
preparing an optical element adapted to be positioned on top of the LED chip for receiving light emitted from the LED chip,
characterized in that
at least one of the substrate and the optical element is provided with means for laterally and angularly aligning the conversion plate with the LED chip, and
the method further comprises:
positioning the conversion plate on top of the LED chip, whereby the alignment means align the conversion plate with the LED chip.
